(19) United States
(12) Patent Application Publication
(10) Pub. No.: US 2020/0157870 A1
(43) Pub. Date: May 21, 2020

(54) HOLLOW TUBE WINDOW REGULATOR

(71) Applicant: Inteva Products, LLC, Troy, MI (US)

(72) Inventor: Brian Staser, Oxford, MI (US)

(21) Appl. No.: 16/198,030

(22) Filed: Nov. 21, 2018

(51) Int. Cl. E05F 11/48; E05F 15/60

(52) U.S. Cl. CPC E05F 11/483; E05Y 2900/55; E05F 15/60

(57) ABSTRACT

An apparatus for raising and lowering a window in an automobile includes a cursor configured to be connected to the window and a guide rail having a hollow tube along which the cursor travels to raise and lower the window.

### BACKGROUND

Exemplary embodiments pertain to the art of vehicles, and more particularly to window regulators for vehicles.

Automobiles typically have windows surrounding the passenger compartment. Windows in doors and especially front doors may be designed to be raised and lowered electrically by an operator. The operator may be the driver or a passenger usually using an interior switch. The physical raising and lowering of a window is performed by an electromechanical device referred to as a window regulator. Unfortunately, a window regulator can add weight to an automobile thereby decreasing its fuel efficiency in addition to adding cost to making the vehicle in a competitive market place. Hence, it would be well received by the automotive industry if improved window regulators were developed.

### BRIEF DESCRIPTION

Disclosed is an apparatus for raising and lowering a window in an automobile. The apparatus includes a cursor configured to be connected to the window and a guide rail having a hollow tube along which the cursor travels to raise and lower the window.

### BRIEF DESCRIPTION OF THE DRAWINGS

The following descriptions should not be considered limiting in any way. With reference to the accompanying drawings, like elements are numbered alike:

FIG. 1 illustrates a side view of an automobile having a window operated by a window regulator;

FIG. 2 depicts aspects of the window regular having a hollow tube rail for guiding the window as it travels up or down;

FIG. 3 depicts aspects of the hollow tube;

FIGS. 4A-4C depict aspects of various cross-sectional shapes of the hollow tube; and

FIG. 5 depicts aspects of a manual window operating system.

### DETAILED DESCRIPTION

A detailed description of one or more embodiments of the disclosed apparatus and method are presented herein by way of exemplification and not limitation with reference to the Figures.

Disclosed are apparatuses for raising and lowering a window of an automobile. The apparatuses may be referred to as “window regulators.” In one or more embodiments, a window regulator is an electromechanical device that can be controlled by a user inside the automobile such as by operating a switch.

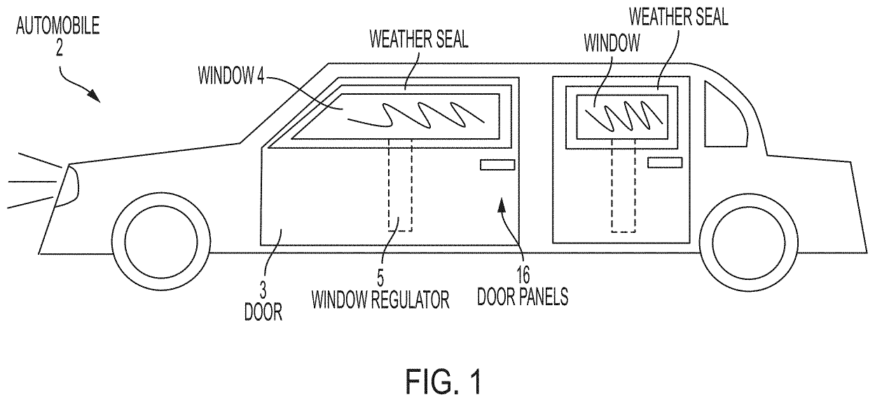

FIG. 1 illustrates a side view of an automobile 2 having a door 3. Disposed in the door 3 is a window 4 that is configured to be raised and lowered by a window regulator 5 disposed within door panels 16 defining a portion of the door. In general, the window regulator 5 is hidden from view. It can be appreciated that one or more other windows 4 in the automobile 2 may also be operated by window regulators similar to the window regulator 5.

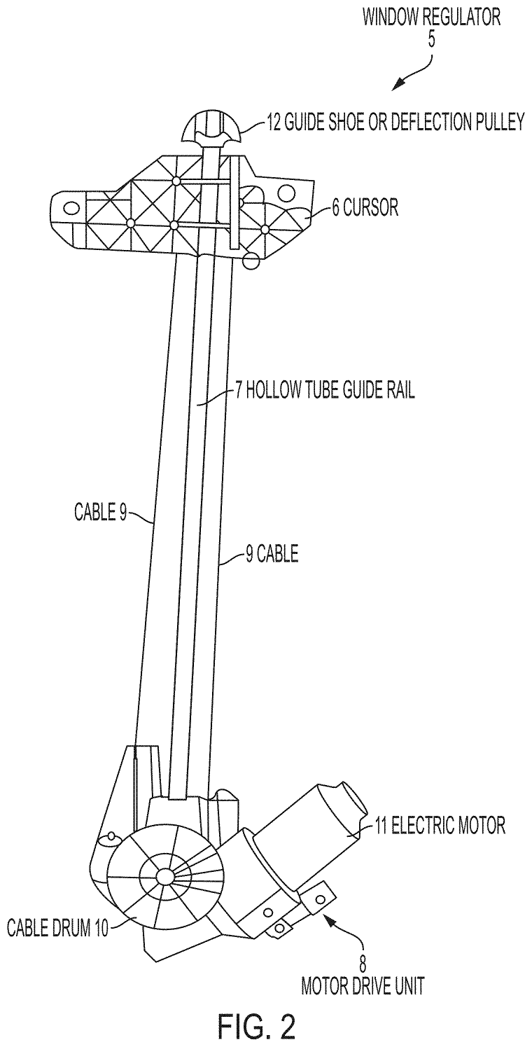

FIG. 2 depicts aspects of the window regulator 5. The window regulator 5 includes a traveler or cursor 6 that is configured to be connected to the window 4 in order to raise and lower the window 4. The cursor 6 is configured to travel along a hollow tube guide rail 7, which is made up of a hollow tube. To save weight, the cursor 6 may be made of a plastic, metal insert reinforced plastic or plastic composite material in one or more embodiments. The window regulator 5 also includes an electric motor drive unit 8 for moving the cursor 6 via a cable 9. The electric motor drive unit 8 includes a cable drum 10 driven by an electric motor 11. The cable drum 10 is configured to wind the cable 9 in two directions. One direction is for raising the window 4 and an opposing direction is for lowering the window 4. In one or more embodiments, the electric motor drive unit 8 is disposed or attached at a lower end of the guide rail 7, while a guide shoe or deflection pulley 12 is disposed or attached at an upper end of the guide rail 7. The guide shoe 12 is configured to guide the cable 9 around the end of the guide rail 7 opposing the end having the electric motor drive unit 8. To guide the cable 9, the guide shoe 12 includes a slot through which the cable slides through. In one or more embodiments, the cable 9 is attached to the cursor 6 at two points such that winding the cable drum 10 in one directions results in pulling the cursor up along the guide rail 7 to raise the window 4, while winding the cable drum 10 in the opposite direction results in pulling the cursor 6 down along the guide rail 7 to lower the window 4. Not shown are a controller for controlling the motor drive unit 8 and inputs to the controller such as user operated switches and a vehicle control module that may also provide input to the controller. Also not shown is an electric power supply system, which may include a battery and alternator. In that automobile electric power supply systems and window controllers are well known in the art, these components are not discussed in further detail.

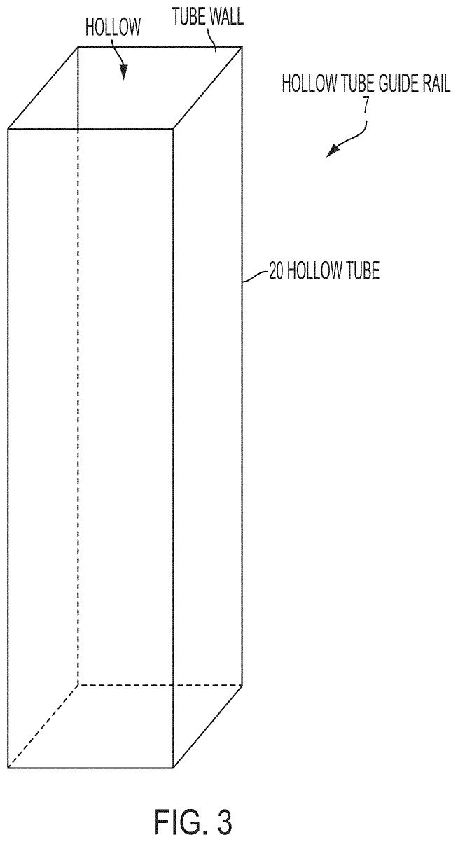

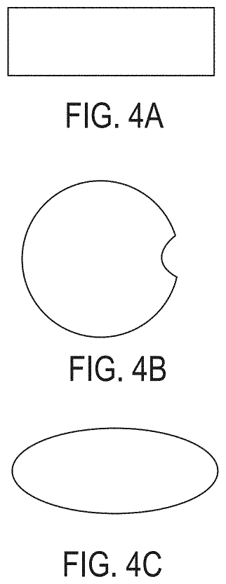

As noted above, the hollow tube guide rail 7 is made of a hollow tube. An embodiment of a hollow tube 20 is illustrated in FIG. 3. In the embodiment of FIG. 3, the hollow tube 20 has a square cross-section. Other cross-sectional geometries or shapes may also be used such as a rectangular cross-sectional shape, a circular cross-sectional shape with one or more longitudinal grooves, or an oval cross-sectional shape as illustrated in FIGS. 4A-4C, respectively. The one or more longitudinal grooves prevent rotation of the cursor 6 about the guide rail 7. Other shapes may also use one or more longitudinal grooves. In one or more embodiments, a shape of an interior portion or the cursor 6 is made to conform to the shape of the hollow tube 20 such that the cursor 6 makes contact with the hollow tube 20 (i.e., the guide rail 7) at at least four different points or locations in order to guide the cursor 6 along the guide rail 7 without having the cursor 6 rotate about the guide rail 7 while traveling. In one or more embodiments, the hollow tube 20 is made of a metal such as aluminum, steel, metallic alloys, a plastic material, or a plastic composite material.

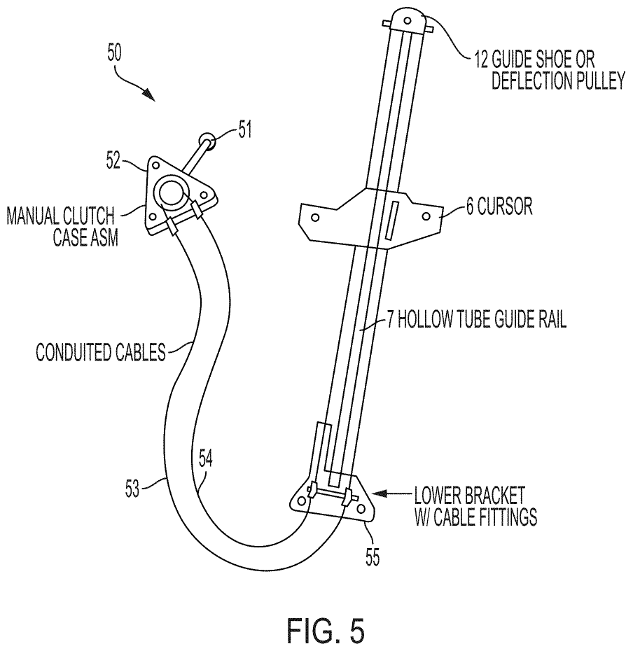

In an alternative embodiment, the window 4 may be may be manually operated by using operator rotational force to raise or lower the window 4. FIG. 5 illustrates a manual window operating system 50. The manual window operating system 50 includes a manual crank handle 51 configured to be turned by an operator where rotation in one direction raises the window 4, while rotation in an opposite direction lowers the window 4. The manual crank handle 51 is attached to a manual clutch case assembly 52 that is configured to convert rotation of the manual crank handle 51 into extension or retraction of a first end of the cable 9 and corresponding retraction or extension of a second end of the cable 9, respectively. The cable 9 may be guided by a lower bracket 55 that is in turn attached to the hollow tube guide rail 7. After being guided by the lower bracket 55, the first end of the cable 9 is attached to the cursor 6, while the second end of the cable 9 is guided around the upper end of the hollow tube guide rail 7 by the guide shoe or deflection pulley 12 and then attached to the cursor 6. With this arrangement, cranking the handle 51 in one direction will pull the cursor 6 up the hollow tube guide rail 7 to raise the window 4, while cranking the handle 51 in the opposite direction will pull the cursor 6 down the hollow guide rail 7 to lower the window 4. It can be appreciated that the cable 9 may be guided from the manual clutch case assembly 52 to the lower bracket 55 using a conduit.

The hollow tube guide rail 7 provides several advantages. One advantage is that the hollow tube provides increased structural rigidity compared to conventional types of guide rails with open sided cross-sections (e.g., a C-shape cross-section) having the same wall thickness. Hence, the wall thickness can be decreased to give the same structural rigidity as conventional or prior art guide rails resulting in a significant weight decrease and thus weight savings. Weight savings can be correlated into better vehicle fuel economy. Another advantage is that the hollow tube is economical to manufacture thus resulting in lower manufacturing costs.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates to one or more structural limitations of a device that are required for the device to perform the function or operation for which the device is configured.

The disclosure illustratively disclosed herein may be practiced in the absence of any element which is not specifically disclosed herein.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An apparatus for raising and lowering a window in an automobile, comprising:
a cursor configured to be connected to the window;
a guide rail comprising a hollow tube along which the cursor travels to raise and lower the window.

2. The apparatus of claim 1, wherein the cursor encircles a portion of the guide rail.

3. The apparatus of claim 2, wherein the cursor configured to slide up and down the guide rail.

4. The apparatus of claim 3, wherein the cursor comprises an open interior portion having a cross-sectional shape that conforms to the cross-sectional shape of the guide rail in order for the cursor to slide along the guide rail.

5. The apparatus of claim 4, wherein the interior portion of the cursor makes contact with the guide rail at at least four different points or locations that prevent the cursor from rotating about the guide rail as the cursor travels along the guide rail.

6. The apparatus of claim 1, further comprising:
an electric motor drive unit configured to power the window up and down;
a cable connected to the cursor and the electric motor drive unit, wherein the cable is configured to pull the cursor in an up direction to raise the window and in a down direction to lower the window; and
a guide shoe or deflection pulley connected to an end of the guide rail and configured to guide the cable as the cable moves to raise and lower the cursor.

7. The apparatus of claim 6, wherein the electric motor drive unit is connected to the guide rail at an end opposing the end where the guide shoe is connected to the guide rail.

8. The apparatus of claim 1, further comprising a manual window operating system configured to use operator force to raise and lower the cursor along the guide rail.

9. The apparatus of claim 1, wherein the manual window operating system comprises a manual crank handle to which the operator force is applied.

10. The apparatus of claim 1, wherein the hollow tube is made of a metal.

11. The apparatus of claim 1, wherein the hollow tube is made of a plastic material, a plastic composite material, or a metal insert reinforced plastic material.

12. The apparatus of claim 1, wherein the hollow tube comprises a square cross-sectional shape.

13. The apparatus of claim 1, wherein the hollow tube comprises a rectangular cross-sectional shape.

14. The apparatus of claim 1, wherein the hollow tube comprises a circular cross-sectional shape with a longitudinal groove.

15. The apparatus of claim 1, wherein the hollow tube comprises an oval cross-sectional shape.
